(19) United States
(12) Patent Application Publication
(10) Pub. No.: US 2025/0033927 A1
(43) Pub. Date: Jan. 30, 2025

(54) SYSTEM AND METHOD FOR DETERMINING THE POSITION OF AN ELEVATOR CAR OF AN ELEVATOR INSTALLATION, SAID ELEVATOR CAR BEING MOVABLY ARRANGED IN AN ELEVATOR SHAFT

(71) Applicant: Inventio AG, Hergiswil (CH)

(72) Inventors: Beat De Coi, Maienfeld (CH); Christian Studer, Kriens (CH); Axel Hosemann, Auw (CH); Udo Graf, Sevelen (CH)

(21) Appl. No.: 18/715,813

(22) PCT Filed: Nov. 22, 2022
(86) PCT No.: PCT/EP2022/082687

§ 371 Date: Jun. 3, 2024

(30) Foreign Application Priority Data
Dec. 9, 2021 (EP) 21213387.0

(51) Int. Cl. B66B 1/34; G01S 7/4915; G01S 17/32

(52) U.S. Cl. CPC B66B 1/3492; G01S 7/4915; G01S 17/32

(57) ABSTRACT

A system determines the position of an elevator car movable in an elevator installation shaft. A transmitter emits modulated electromagnetic radiation with a first modulation frequency as a first output signal, a sensor cell receives electromagnetic radiation reflected by a detected object as an original measurement signal, and an evaluation unit, communicating with the transmitter and the sensor cell, delays the original measurement signal thus generating a delayed measurement signal, determines a first phase offset between the original measurement signal and the first output signal, determines a second phase offset between the delayed measurement signal and the first output signal, selects either the first phase offset or the second phase offset based upon a selection condition to determine a position of the elevator car within a portion of the elevator shaft, and determines the elevator car position based upon the elevator shaft portion and the position within the portion.

### FIELD

The invention relates to a system for determining the position of an elevator car, movably arranged in an elevator shaft, of an elevator installation, and to a method for determining the position of an elevator car, movably arranged in an elevator shaft, of an elevator installation.

### BACKGROUND

Elevator installations are used to transport persons and/or goods between floors of buildings. For this purpose, at least one elevator car accommodating passengers and/or goods is moved in an elevator shaft—in particular, vertically between the floors. The position of the elevator car in the elevator shaft must be determined and processed by an elevator control system—particularly in order to be able to stop the elevator car precisely at a floor and to ensure that the elevator car only moves in a permitted region of the elevator shaft. A large number of systems are known for determining the position of an elevator car in an elevator shaft, based upon a wide variety of measuring designs.

DE 10126585 A1 describes a system for determining the position of an elevator car of an elevator unit, the elevator car being movably arranged in an elevator shaft. The system has a laser having a transmitter for emitting modulated electromagnetic radiation in the form of a laser beam. The laser also has a sensor that receives the laser beam reflected by a mirror. Either the laser or the mirror is attached in an immovable position in the elevator shaft, while the other device is fastened to the elevator car and moves together therewith. The position of the elevator car is determined based upon the propagation time of the laser beam from the transmitter to the receiver. The laser beam is modulated with two modulation frequencies, one of which provides a coarse position of the elevator car and the other a fine position of the elevator car. The position of the elevator car is determined from the coarse position and the fine position. DE 10126585 A1 thus determines the position of the elevator car according to the so-called time-of-flight (TOF) method.

TOF methods for distance measurement are often based upon the fact that a phase offset of a reflected electromagnetic radiation received by a sensor is determined relative to a modulated electromagnetic radiation emitted by a transmitter. In such TOF methods for distance measurement, the higher the modulation frequency of the electromagnetic radiation used, the higher the accuracy. However, the phase offset of the reflected electromagnetic radiation relative to the emitted electromagnetic radiation can be determined unambiguously only in a range between 0 and 360° or 0 and 2π rad. Because the electromagnetic radiation must travel twice the distance between the transmitter and the object reflecting the electromagnetic radiation, the distance between the transmitter and the object can thus be unambiguously determined only in a portion-here called an unambiguity portion—with a length equal to half the wavelength of the electromagnetic radiation. The wavelength of the electromagnetic radiation results from the quotient of its propagation velocity, i.e., the speed of light (3*10⁸ m/s) and its modulation frequency. For example, the wavelength is 15 m at a modulation frequency of 20 MHZ (3*10⁸/20*10⁶ m). The aforementioned unambiguity portion in which the aforementioned distance can be unambiguously determined thus has a length of 7.5 m in this case. The position or location within an unambiguity portion, i.e., a distance from a start of the unambiguity portion, is in this case directly proportional to the aforementioned phase offset.

If distances from an object are to be measured using a TOF method based upon the determination of the phase offset, which are larger than an unambiguity portion of the modulation frequency required for a desired accuracy, it is first necessary to determine in which of a plurality of adjacent unambiguity portions the object is arranged. This can be realized, for example, by using a further modulation frequency. A comparatively low second modulation frequency can first be selected at which the associated unambiguity portion covers the entire required measurement range. For example, if a maximum distance of 100 m is to be measured, then the second modulation frequency must be not more than 1.5 MHZ (3*10⁸/100/2 Hz). The measurement with the second modulation frequency provides an approximate distance from the object.

The exact distance is then determined using a first, higher modulation frequency, at which, as described above, a plurality of adjacent unambiguity portions result within the required measurement range. If 20 MHz is used as the first modulation frequency and thus a length of the unambiguity sections is 7.5 m, the entire measurement range of 100 m is divided into a total of 14 adjacent unambiguity portions in the example mentioned. By means of the aforementioned approximate distance, for example, a first step is to determine in which unambiguity portion the object is located. In the second step, as described, the position of the object within the unambiguity portion is determined. Together with the information about the unambiguity portion in which the object is located, this results in the exact distance of the object from the transmitter or receiver of the electromagnetic radiation.

Applied to the determination of the position of an elevator car in an elevator shaft, this means that the distance between the transmitter or the receiver of the electromagnetic radiation and the detected object, i.e., the elevator car, can be determined very accurately in the case of a stationary transmitter or receiver, or an end of the elevator shaft in the case of a transmitter or receiver arranged on the elevator car. Based upon this distance and the knowledge of the arrangement of the transmitter or receiver, it is possible to infer the position of the elevator car in the elevator shaft.

In the described determination of the position of an object within an unambiguity portion, very small or very large phase offsets between the reflected electromagnetic radiation and the emitted electromagnetic radiation must be determined at the edges of the unambiguity portion. Such small or large phase offsets are difficult to determine accurately, resulting in a determination of the position of the object in the aforementioned edge regions which is not very accurate.

### SUMMARY

In contrast, it is in particular an object of the invention to propose a system and a method for determining the position of an elevator car of an elevator unit which is movably arranged in an elevator shaft, which system and method in particular allow the position of an elevator car in an elevator shaft to be determined particularly accurately and yet at a low cost and with little installation effort. According to the invention, this object is achieved by a system and by a method having the features described herein.

The embodiments described below relate equally to the system and to the method. In other words, features mentioned below for example with reference to the system can also be implemented as method steps, and vice versa. The system is thus designed and configured in particular such that it can carry out the described methods, i.e., the described methods can be carried out by the system.

The system according to the invention for determining the position of an elevator car of an elevator installation, the elevator car being movably arranged in an elevator shaft, has a transmitter for emitting modulated electromagnetic radiation with a first modulation frequency as a first output signal, a sensor cell for receiving electromagnetic radiation, reflected by an object detected by the sensor cell, as an original measurement signal, and an evaluation unit which is in communication with the transmitter and the sensor cell. Either the transmitter and the sensor cell are immovably arranged in the elevator shaft such that the sensor cell detects at least a part of the elevator car as an object, or the transmitter and the sensor cell are arranged on the elevator car such that the sensor cell detects at least a part of the elevator shaft—in particular, a part of a shaft end—as an object. According to the invention, the evaluation unit is configured so as to
delay the original measurement signal by a delay time and thus generate a delayed measurement signal,
determine a first phase offset between the original measurement signal and the first output signal,
determine a second phase offset between the delayed measurement signal and the first output signal,
select either the first phase offset or the second phase offset on the basis of a selection condition in order to determine a position of the elevator car within a portion of the elevator shaft from the phase offset, and
determine the position of the elevator car in the elevator shaft on the basis of an arrangement of the aforementioned portion in the elevator shaft and the aforementioned position within the portion.

It is thus made possible that, in order to determine the position of the elevator car within a portion of the elevator shaft at any point in time, i.e., independently of the position of the elevator car in the elevator shaft, a phase offset can be used which is not close to 0 or close to 360° or 2π rad and can thus be accurately determined. The accurate determination of the phase offset used, which is possible at any position of the elevator car in the elevator shaft, thus allows for accurate determination of the position of the elevator car throughout the entire elevator shaft.

The delay of the original measurement signal by the aforementioned delay time and the use of the second phase offset cause a displacement of the adjacent unambiguity portions away from the transmitter or receiver of the electromagnetic radiation. The original unambiguity portions are thereby displaced by a displacement distance. The displacement distance corresponds to half the distance covered by the electromagnetic radiation in the delay time. The displaced unambiguity portions thus result from the original unambiguity portions. The second phase offset can be used to determine the position of the elevator car within a displaced unambiguity portion. The position of the elevator car within a portion of the elevator shaft can also be referred to as the position of the elevator car within the corresponding portion. When determining the position of the elevator car in the elevator shaft from the information about the displaced unambiguity portion in which the elevator car is located and from the position of the elevator car in this displaced unambiguity portion, the aforementioned displacement distance is then additionally taken into account.

The mentioned object is also achieved by a method for determining the position of an elevator car, movably arranged in an elevator shaft, of an elevator unit with a system described above for determining the position of an elevator car, movably arranged in an elevator shaft, of an elevator unit. The evaluation unit
delays the original measurement signal by a delay time and thus generates a delayed measurement signal,
determines a first phase offset between the original measurement signal and the first output signal,
determines a second phase offset between the delayed measurement signal and the first output signal,
selects either the first phase offset or the second phase offset on the basis of a selection condition and determines a position of the elevator car within a portion of the elevator shaft from the phase offset, and
determines the position of the elevator car in the elevator shaft on the basis of an arrangement of the aforementioned portion in the elevator shaft and the aforementioned position within the portion.

The transmitter, the sensor cell, and the evaluation unit are arranged in close spatial proximity to each other—for example, in a common housing. However, it is also possible for the combination of transmitter and sensor cell on the one hand and the evaluation unit on the other to be arranged spatially apart from one another. It is also possible for the evaluation unit to consist of a plurality of parts or modules which are in communication with one another and which can be arranged at least partially in the combination of transmitter and sensor cell or at a distance therefrom. At least one module of the evaluation unit can also be designed as a control device which executes other control tasks in the elevator installation.

The transmitter can have its own control device which is in communication with the evaluation unit. It is also possible for the evaluation unit to actuate the transmitter to emit the modulated electromagnetic radiation. The modulated electromagnetic radiation can be designed, for example, as a laser beam or as infrared radiation. The first modulation frequency can, for example, be between 10 and 50 MHz—in particular, 20 MHz.

The transmitter and the sensor cell are immovably arranged in the elevator shaft such that the sensor cell detects at least a part of the elevator car as an object. They are in particular arranged at one end of the elevator shaft. It is also possible for the transmitter and the sensor cell to be arranged on the elevator car such that the sensor cell detects at least a part of the elevator shaft as an object. The sensor cell in particular detects a part of an end of the elevator shaft as an object, i.e., in particular, a shaft ceiling or a shaft floor.

Thus, either the object to be detected in the form of an elevator car or the transmitter and the sensor cell are moved with the elevator car in the elevator shaft, and the corresponding other part is arranged immovably—in particular, at an end of the elevator shaft. Since the elevator shaft is mainly aligned vertically, either the object to be detected or the transmitter and the sensor cell are arranged in particular immovably at the lower end or at the upper end of the elevator shaft. The position or height at which the object to be detected or the transmitter and the sensor cell are arranged in the elevator shaft is known. It is also known at which point the corresponding other part is arranged on the elevator car. In this way, the position of the elevator car in the elevator shaft can be determined from the aforementioned fixed position of the object to be detected or of the transmitter and the sensor cell in the elevator shaft, and a distance between the detected object and the transmitter or the sensor cell determined by means of the evaluation unit. In the case of a vertically aligned elevator shaft, the position of the elevator car in the elevator shaft determines the height at which the elevator car is located.

The sensor cell receives the electromagnetic radiation reflected from the detected object and generates therefrom the original measurement signal, which is initially present as an analog measurement signal. The analog signal is converted to a digital signal using an analog-to-digital converter, which is also referred to below as the original measurement signal. The analog-to-digital converter is in particular part of the evaluation unit, but can also be part of the sensor cell.

The delayed measurement signal is generated from the original measurement signal. The delayed measurement signal is thereby delayed by the delay time; it thus follows the original measurement signal with a time interval corresponding to the delay time. The aforementioned delay and thus the generation of the delayed measurement signal is implemented in software in particular within the evaluation unit.

It is also possible for more than one delayed measurement signal to be generated from the original measurement signal. For example, a first delayed measurement signal can be delayed by one third of the period duration of the modulation frequency, and a second delayed measurement signal can be delayed by two thirds of the period duration of the modulation frequency.

The position of the elevator car in the elevator shaft is determined in particular at a fixed cycle—for example, every 10 ms. It is not absolutely necessary for the delayed measurement signal to be generated each time the position of the elevator car in the elevator shaft is determined. If, for example, it is clear that the position of the elevator car in the elevator shaft is determined based upon the original measurement signal, the generation of the delayed measurement signal and thus also the determination of the second phase offset can be dispensed with. Analogously, the determination of the first phase offset can be dispensed with if the position of the elevator car is reliably determined based upon the second phase offset.

The evaluation unit selects the first phase offset or the second phase offset on the basis of a selection condition in order to determine the position of the elevator car within a portion of the elevator shaft on the basis of the phase offset. If the first phase offset is selected, the position of the elevator car within an original unambiguity portion described above is determined. If the second phase offset is selected, the position of the elevator car within a displaced unambiguity portion described above is determined. A selection condition can, for example, be that the first phase offset is selected if it is greater than a lower limit value, e.g., 90° or π/2 rad, and less than an upper limit value—for example, 270° or 3*π/2 rad. If this is not the case, the second phase offset is selected.

The arrangement of the aforementioned portion in the elevator shaft in which the elevator car is located, i.e., the arrangement of the original unambiguity portion or of the displaced unambiguity portion, can be determined, for example, as described above using a second modulation frequency. The second modulation frequency is selected in particular as described above such that the unambiguity portion resulting from the second modulation frequency extends over the entire desired measurement range, i.e., in this case, over the entire elevator shaft.

In one embodiment of the invention, the evaluation unit is configured, when the aforementioned selection condition is checked, to
determine a first time interval between a maximum of the first output signal and an associated maximum of the original measurement signal,
determine a second time interval between a maximum of the first output signal and an associated maximum of the delayed measurement signal,
compare the first time interval and the second time interval, and,
in the event that the first time interval is greater than or greater than or equal to the second time interval, select the first phase offset, and,
in any other case, select the second phase offset in order to determine a position of the elevator car within a portion of the elevator shaft from the phase offset.

It is thereby ensured in a simple manner that no phase offset is used to determine the position of the elevator car in the elevator shaft which is close to 0 or 360° or 2π rad.

When determining the aforementioned time interval, it is not taken into account whether the maximum of the first output signal is before or after the maximum of the original or delayed measurement signal. Instead of determining the time interval between two associated maxima, the time interval between two other points of the first output signal and the original or delayed measurement signal can also be determined equivalently and used in the check of the selection condition. For example, the zero crossings can be used with a positive slope.

In one embodiment of the invention, the evaluation unit is configured to check, in the event that, in a preceding selection, it selected the first phase offset or the second phase offset as a selection condition, whether the time interval between a maximum of the first output signal and an associated maximum of the measurement signal used to determine the selected phase offset is greater than a limit value, and to maintain the selected phase offset if the result of the check is positive. The limit value can, for example, be a quarter of the period duration of the first output signal.

This advantageously eliminates the need to determine both of the aforementioned intervals each time the position of the elevator car in the elevator shaft is determined. In many cases, determining one time interval is sufficient, which requires less computing effort than determining two time intervals.

The aforementioned selection of a phase offset is in particular carried out the last time the position of the elevator car in the elevator shaft is determined. As already explained, the time interval between two other points of the first output signal and the original or delayed measurement signal associated with one another can be used equivalently.

In one embodiment of the invention, the aforementioned delay time for generating the delayed measurement signal from the original measurement signal is half a period duration of the first output signal. This ensures that the phase offset used to determine the position of the elevator car in the elevator shaft is at a maximum distance from the edges of the possible range of the phase offset, i.e., a maximum distance from 0 and 360° or 2π rad. Particularly accurate determination of the phase offset used to determine the position of the elevator car in the elevator shaft, and thus particularly accurate determination of the position of the elevator car within a portion of the elevator shaft, is thus possible.

When using the half period duration of the first output signal as the delay time for generating the delayed measurement signal from the original measurement signal, the evaluation unit is configured, in particular, to check, when the aforementioned selection condition is checked, whether the first phase offset is greater than 90° or π/2 rad and less than 270° or 3*π/2 rad. If this is the case, the evaluation unit selects the first phase offset, and, in any other case, it selects the second phase offset in order to determine the portion of the elevator shaft in which the elevator car is located from the phase offset.

The selection condition can thus be implemented particularly easily, and thus with very little computing effort.

In one embodiment of the invention, the transmitter is configured to emit modulated electromagnetic radiation with a second modulation frequency, lower than the first modulation frequency, as a second output signal, and the evaluation unit is configured to determine, on the basis of the second output signal, the portion of the elevator shaft in which the elevator car is currently located.

Thus, as described above in connection with TOF methods for distance measurement, the portion of the elevator shaft in which the elevator car is currently located can be determined in a simple manner. The second modulation frequency is selected such that the length of the resulting unambiguity portion is greater than the maximum distance between the transmitter or sensor cell and the object to be detected. The aforementioned length is, for example, greater than the height of the elevator shaft.

Configuration of the transmitter means in particular that the control device controlling the transmitter, i.e., for example, a control device integrated into the transmitter, or the evaluation unit is configured accordingly.

In one embodiment of the invention, the transmitter is configured to transmit the second output signal only when the elevator car is at a standstill. The portion of the elevator shaft in which the elevator car is currently located can thus be determined particularly reliably.

If the elevator car is moving, the portion of the elevator shaft in which the elevator car is currently located can be determined, for example, from the corresponding portion during the last determination of the elevator car and its speed. In this case, the speed of the elevator car can be determined from the positions over time by derivation. It is also possible for the aforementioned portion to be determined on the basis of plausibility considerations. If, for example, the elevator car was located at a lower edge of an unambiguity portion during the last determination of its position in the elevator shaft and is located at an upper edge of an unambiguity portion during the current determination of its position in the elevator shaft, it can be concluded that it is currently located in an unambiguity portion following the unambiguity portion of the last determination below. Such plausibility considerations are possible if the first modulation frequency, the maximum speed and acceleration of the elevator car, and the cycle of the determination of the position of the elevator car in the elevator shaft have been coordinated with one another by a person skilled in the art.

In one embodiment of the invention, the transmitter is configured to emit the second output signal only when the evaluation unit has no information about the portion of the elevator shaft in which the elevator car is currently located. It is thus rarely necessary to use the second output signal, which allows for continuous, accurate determination of the position of the elevator car in the elevator shaft.

The emission of the second output signal with the second, lower modulation frequency, i.e., the determination of the approximate position of the elevator car in the elevator shaft, is in particular only necessary if the power supply of the system has been interrupted, i.e., the system has to be restarted. However, it is also possible that the approximate position of the elevator car in the elevator shaft is also determined independently of a restart of the system.

An approximate position of the elevator car in the elevator shaft can also be determined, for example, by the transmitter emitting an electromagnetic radiation having a special modulation pattern, and the evaluation unit determining the time period until the aforementioned modulation pattern is received by the sensor cell. The aforementioned time period can be used to determine the approximate position of the elevator car in the elevator shaft.

In one embodiment of the invention, the sensor cell is part of a 3-D sensor having a plurality of such sensor cells. In particular, the 3-D sensor and the evaluation unit are part of a so-called 3-D camera. 3-D cameras are commercially available at comparatively low prices.

The 3-D sensor is designed in particular as a photonic mixing detector, also known as a PMD sensor (photonic mixing device), whose functional principle is based upon the TOF method. In this case, the 3-D camera comprising the 3-D sensor is designed as a so-called TOF camera. The 3-D sensor is then configured to determine, for each sensor cell, a phase offset of the electromagnetic radiation emitted by the transmitter and reflected by the detected object, and to transmit it to the evaluation unit via the aforementioned communications link. The evaluation unit is then configured to determine, on the basis of the aforementioned phase offsets, the distance of each sensor cell from a part, detected by this sensor cell, of the object detected by the 3-D sensor. The 3-D sensor can, for example, have a plurality of TOF distance sensors described in EP 2743724 B1, wherein each of the TOF distance sensors corresponds to a sensor cell.

The sensor cells of the 3-D sensor are in particular arranged in a matrix arrangement. A sensor cell can also be referred to as a pixel of the 3-D sensor. The 3-D sensor can have, for example, 160×60 or 320×240 sensor cells.

It must be noted that some of the possible features and advantages of the invention are described herein with reference to different embodiments of the system according to the invention and the method according to the invention. A person skilled in the art recognizes that the features may be combined, adapted, transferred, or exchanged as appropriate in order to yield other embodiments of the invention.

A system described above and a corresponding method can also be used to determine the distance between the transmitter or sensor cell and any object. The use is thus not limited to determining a position of the elevator car in an elevator shaft. The above statements apply analogously in this case.

This would result in a system for determining the distance from an object with
a transmitter for emitting modulated electromagnetic radiation with a first modulation frequency as a first output signal,
sensor cell for receiving electromagnetic radiation reflected by the sensor cell as an original measurement signal, and
an evaluation unit which has a communications connection to the transmitter and the sensor cell,
   characterized in that
   the evaluation unit is configured to
delay the original measurement signal by a delay time and thus generate a delayed measurement signal,
determine a first phase offset between the original measurement signal and the first output signal,
determine a second phase offset between the delayed measurement signal and the first output signal,
select either the first phase offset or the second phase offset on the basis of a selection condition in order to determine a position of the object within a portion of a measurement range of the system from the phase offset, and
determine the distance of the object from the transmitter or the sensor cell on the basis of an arrangement of the aforementioned portion in the measuring range of the system and the aforementioned position within the portion.

Further advantages, features, and details of the invention can be found in the following description of embodiments and with reference to the drawings, in which like or functionally like elements are provided with identical reference signs. The drawings are merely schematic and not true-to-scale.

### DESCRIPTION OF THE DRAWINGS

In the figures:

FIG. 1 is a schematic representation of an elevator installation with a system for determining the position of an elevator car arranged movably in an elevator shaft,

FIG. 2 is a first example of a time profile of a first output signal and an associated original measurement signal,

FIG. 3 is a second example of a time profile of the first output signal and the associated original measurement signal, and

FIG. 4 shows the time profile of the first output signal and an associated delayed measurement signal which results from the original measurement signal according to FIG. 3.

### DETAILED DESCRIPTION

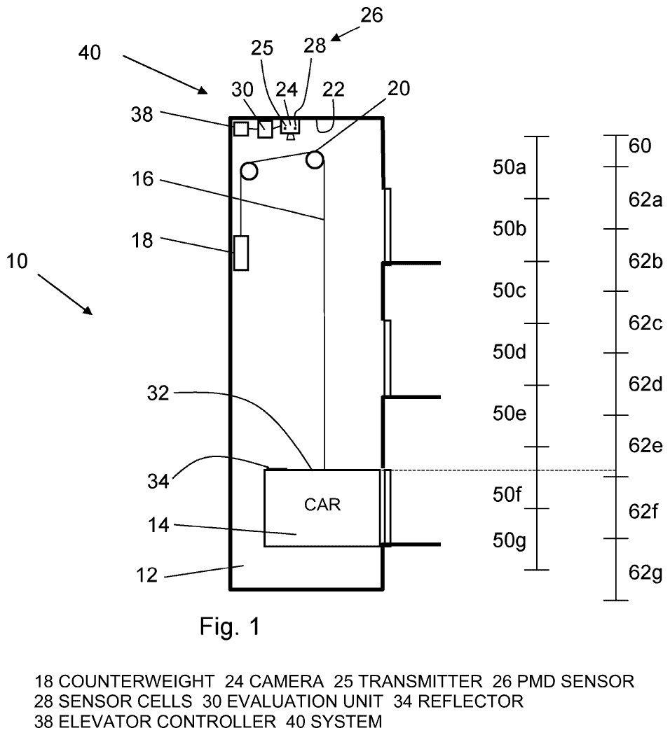

According to FIG. 1, an elevator installation 10 has an elevator shaft 12 movable in the vertical direction. An elevator car 14 is arranged within the elevator shaft 12, which car is connected to a counterweight 18 in a known manner via a support means 16 in the form of a flexible belt or a cable. Starting from the elevator car 14, the support means 16 runs over a drive pulley 20, which can be driven by a drive machine (not shown). The elevator car 14 can be moved up and down in the elevator shaft 12 by means of the drive machine and the support means 16.

A 3-D camera in the form of a TOF camera 24 is immovably arranged on a shaft ceiling 22 of the elevator shaft 12. The TOF camera 24 has a transmitter 25 for emitting electromagnetic radiation, and a 3-D sensor in the form of a PMD sensor 26 for receiving electromagnetic radiation. The PMD sensor 26 has a total of 36 sensor cells 28, which are arranged in 6 columns and 6 rows. The PMD sensor 26 is configured to transmit, for each sensor cell 28, an original measurement signal corresponding to the received electromagnetic radiation to the evaluation unit 30. The transmitter 25 transmits an output signal corresponding to the emitted electromagnetic radiation to the evaluation unit 30.

A reflector 34 is arranged on a car ceiling 32 of the elevator car 14. The reflector 34 is arranged such that it reflects electromagnetic radiation emitted by the transmitter 25 of the TOF camera 24 to the TOF camera 24 and thus to the PMD sensor 26. In an installation phase, the TOF camera 24 and thus also the PMD sensor 26 are arranged and aligned in such a way that the PMD sensor 26 detects at least the reflector 34 as an object. Particular care is taken here to ensure that the reflector 34 is detected by the PMD sensor 26 at every possible position of the elevator car 14 in the elevator shaft 12, i.e., over the entire range of travel of the elevator car 14. To determine the position of the elevator car 14 in the elevator shaft 12, i.e., to determine the height at which the elevator car 14 is located in the elevator shaft 12, the TOF camera 24 and thus the PMD sensor 26 detect at least the reflector 34.

The position of the elevator car 14 in the elevator shaft 12 is determined in particular only based upon the sensor cells 26 detecting the reflector 34. The results of the individual sensor cells 26 can be averaged, for example. The sensor cells 26 detecting the reflector 34 can, for example, be determined from the intensity of the reflected electromagnetic radiation which is detected by the individual sensor cells 26. In the case of sensor cells that detect the reflector 34, the intensity is significantly higher than in sensor cells that do not detect the reflector 34. The evaluation of the measurement signal of a single sensor cell is described below.

To determine the position of the elevator car 14 in the elevator shaft 12, the evaluation unit 30 initially determines an approximate position of the elevator car 14 in the elevator shaft 12. For this purpose, the transmitter 25 emits an electromagnetic radiation with a second modulation frequency, which results in an unambiguity portion having a length greater than the height of the elevator shaft 12. If the height of the elevator shaft 12 is 50 m, for example, the second modulation frequency can be 1.5 MHZ, for example, which results in a length of the unambiguity portion of 100 m. The evaluation unit 30 determines the phase offset between the received and the emitted electromagnetic radiation, and thus calculates an approximate distance between the 3-D sensor 26 and the elevator car 14 and thus the approximate position of the elevator car 14 in the elevator shaft 12. The described determination of the approximate position of the elevator car 14 in the elevator shaft 12 is carried out in particular only when the elevator car is at a standstill.

After the approximate position of the elevator car 14 in the elevator shaft 12 is determined, the transmitter 25 emits an electromagnetic radiation with a first modulation frequency that is, for example, 20 MHz higher than the second modulation frequency. This results in a length of an unambiguity portion 50a-50g of 7.5 m. The individual unambiguity portions 50a-50g are each adjacent to one another, as shown in FIG. 1, wherein the uppermost unambiguity portion 50a begins in the 3-D sensor 26 in the example shown. With the approximate position of the elevator car 14 in the elevator shaft 12, the evaluation unit 30 determines the unambiguity portion (in FIG. 1, the unambiguity portion 50f) in which the elevator car 14 is currently located. The arrangement in the elevator shaft 12 of the unambiguity portion 50f in which the elevator car 14 is currently located is thus also known.

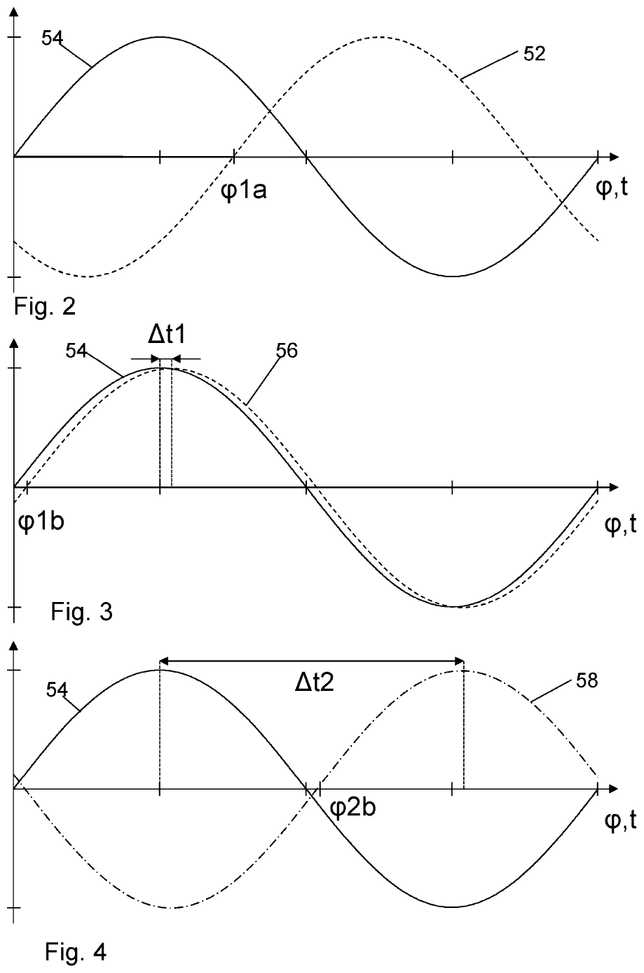

The evaluation unit 30 then determines the position of the elevator car 14 within the previously determined unambiguity portion 50f using the electromagnetic radiation with the first modulation frequency. For this purpose, in a first example, it first determines a first phase offset between the original measurement signal 52 shown in FIG. 2 and the output signal 54. The first phase offset φ1a in FIG. 2 corresponds to the angle at which the original measurement signal 52 assumes the value 0 and has a positive slope. In the next step, the evaluation unit 30 then checks whether the first phase offset φ1a is greater than 90° or π/2 rad and less than 270° or 3*π/2 rad. In the example shown in FIG. 2, the first phase offset φ1a is 134° or 2.34 rad, which satisfies the aforementioned condition. In the case of the satisfied condition, the evaluation unit 30 selects the first phase offset φ1a for further processing. Then, as described above, it determines the position of the elevator car 14 within the previously determined unambiguity portion 50f on the basis of the first phase offset φ1a. Using the known arrangement of the unambiguity portion 50f in the elevator shaft 12 and the position of the elevator car 14 within the unambiguity portion 50f, the evaluation unit 30 determines the position of the elevator car 14 in the elevator shaft 12. The described condition for using the first phase offset can be referred to as a selection condition.

The determination of the position of the elevator car 14 within a portion of the elevator shaft 12 is described in a second example with reference to FIGS. 3 and 4. For this purpose, the evaluation unit 30 first determines a first phase offset between a further original measurement signal 56 shown in FIG. 3 and the output signal 54. The first phase offset φ1b in FIG. 3 corresponds to the angle at which the original measurement signal 56 assumes the value 0 and has a positive slope. In the next step, the evaluation unit 30 then checks whether the first phase offset φ1b is greater than 90° or π/2 rad and less than 270° or 3*π/2 rad. In the example shown in FIG. 3, the first phase offset φ1b is 6° or 0.11 rad, which does not satisfy the aforementioned condition. As a result, the evaluation unit 30 generates a delayed measurement signal 58 shown in FIG. 4 from the original measurement signal. For this purpose, the evaluation unit 30 delays the further original measurement signal 56 by half a period of the first output signal 54. At a modulation frequency of 20 MHz, the delay is 25 ns. The aforementioned time delay corresponds in the angular range to a displacement by 180° or IT rad or, in the representations according to FIGS. 3 and 4, to a mirroring of the further original measurement signal 56 on the x-axis.

The evaluation unit 30 then determines a second phase offset φ2b of the delayed measurement signal 58 relative to the first output signal 54, analogously to the determination of the first phase offset φ1b according to FIG. 3. The second phase offset φ2b in FIG. 4 corresponds to the angle at which the delayed measurement signal 58 assumes the value 0 and has a positive slope. In the example shown in FIG. 4, the second phase offset φ2b is 186° or 3.25 rad.

The delay of the original measurement signal for generating the delayed measurement signal results in a displacement of the unambiguity ranges by a displacement distance 60 (see FIG. 1). The displacement distance 60 corresponds to half the distance covered by the electromagnetic radiation in the delay time. If the delay time is, as in the example described here, half the period of the output signal 54 with a modulation frequency of 20 MHZ, then the displacement distance 60 has a length of 3.75 m. This results in the displaced unambiguity portions 62a-62g shown in FIG. 1.

With the aforementioned approximate position of the elevator car 14 in the elevator shaft 12, the evaluation unit 30 determines the displaced unambiguity portion (in FIG. 1, the unambiguity portion 62e) in which the elevator car 14 is currently located. The arrangement in the elevator shaft 12 of the displaced unambiguity portion 62e in which the elevator car 14 is currently located is thus also known. Then, as described above, the evaluation unit 30 determines the position of the elevator car 14 within the previously determined displaced unambiguity portion 62e on the basis of the second phase offset φ2b. Using the known arrangement of the displaced unambiguity portion 62e in the elevator shaft 12, the length of the displacement distance 60, and the position of the elevator car 14 within the displaced unambiguity portion 62e, the evaluation unit 30 determines the position of the elevator car 14 in the elevator shaft 12. The described condition for using the second phase offset instead of the first phase offset can be referred to as a selection condition.

The evaluation unit 30 transmits the position of the elevator car 14 to an elevator controller 38, which uses it for example to control the drive machine.

A system 40 for determining the position of the elevator car 14 of the elevator installation 10 movably arranged in the elevator shaft 12 thus has a transmitter 25, a sensor cell 28 as part of a 3-D sensor in the form of the PMD sensor 26, and the evaluation unit 30.

It is also possible for the evaluation unit to determine the delayed measurement signal and the second phase offset each time the position of the elevator car in the elevator shaft is determined, i.e., regardless of whether or not they are needed to determine the position of the elevator car within an unambiguity portion.

In this case, the evaluation unit in particular determines a first time interval Δt1 (see FIG. 3) between a maximum of the first output signal 54 and an associated maximum of the further original measurement signal 56. It additionally determines a second time interval Δt2 (see FIG. 4) between a maximum of the first output signal 54 and an associated maximum of the delayed measurement signal 58. It then compares the first time interval Δt1 and the second time interval Δt2. If the first time interval Δt1 is greater than or greater than or equal to the second time interval Δt2, the evaluation unit selects the first phase offset φ1b, and, in any other case, it selects the second phase offset φ2b in order to determine a position of the elevator car within the unambiguity portion or displaced unambiguity portion in which the elevator car is currently located from the phase offset.

It is also possible for the evaluation unit to be configured to check, in the event that, in a preceding selection, it selected the first phase offset or the second phase offset as a selection condition, whether the time interval (Δt1 or Δt2) between a maximum of the first output signal and an associated maximum of the measurement signal used to determine the selected phase offset is greater than a limit value, and to maintain the selected phase offset if the result of the check is positive. The limit value can, for example, be a quarter of the period duration of the first output signal.

The transmitter 25 can also be configured to emit the second output signal only when the evaluation unit has no information about the portion of the elevator shaft in which the elevator car is currently located. The emission of the second output signal with the second, lower modulation frequency, i.e., the determination of the approximate position of the elevator car in the elevator shaft, is in particular only necessary if the power supply of the system has been interrupted, i.e., the system has to be restarted.

It is also possible for the TOF camera 24 to be arranged on a shaft floor and for the reflector to be arranged on a car floor of the elevator car. It is also possible for the TOF camera to be arranged on the elevator car and for the reflector to be arranged immovably in the elevator shaft. It is also possible for a laser to be used instead of the 3-D camera.

Finally, it should be noted that terms such as “having,” “comprising,” etc., do not preclude other elements or steps, and terms such as “a” or “an” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A system for determining a position of an elevator car movable in an elevator shaft of an elevator installation, the system comprising:
a transmitter emitting modulated electromagnetic radiation with a first modulation frequency as a first output signal;
a sensor cell generating an original measurement signal in response to receiving and detecting electromagnetic radiation reflected by an object;
an evaluation unit having a communication connection to the transmitter and to the sensor cell;
wherein the transmitter and the sensor cell are immovably arranged in the elevator shaft such that the sensor cell detects at least a part of the elevator car as the object, or the transmitter and the sensor cell are arranged on the elevator car such that the sensor cell detects at least a part of the elevator shaft as the object; and
wherein the evaluation unit is adapted to
delay the original measurement signal by a predetermined delay time to generate a delayed measurement signal,
determine a first phase offset between the original measurement signal and the first output signal,
determine a second phase offset between the delayed measurement signal and the first output signal,
select either the first phase offset or the second phase offset based upon a predetermined selection condition and determine a position of the elevator car within a portion of the elevator shaft from the selected phase offset, and
determine a position of the elevator car in the elevator shaft based upon an arrangement of the portion in the elevator shaft and the position of the elevator car within the portion.

12. The system according to claim 11 wherein the evaluation unit is adapted to determine the position of the elevator car within the portion of the elevator shaft from the selected phase offset by:
when the predetermined selection condition exists, determine a first time interval between a maximum of the first output signal and an associated maximum of the original measurement signal, determine a second time interval between the maximum of the first output signal and an associated maximum of the delayed measurement signal, compare the first time interval and the second time interval, and when the first time interval is greater than or greater than or equal to the second time interval select the first phase offset; and
when the predetermined selection condition does not exist, select the second phase offset.

13. The system according to claim 11 wherein the evaluation unit determines whether the first phase offset or the second phase offset was selected in a preceding phase offset selection, checks whether a time interval between a maximum of the first output signal and an associated maximum of the selected phase offset measurement signal used to determine the selected phase offset is greater than a predetermined limit value, and maintains the selected phase offset when the time interval is greater than the predetermined limit value.

14. The system according to claim 11 wherein the predetermined delay time for generating the delayed measurement signal from the original measurement signal is half a period duration of the first output signal.

15. The system according to claim 14 wherein when the predetermined selection condition exists, the evaluation unit is adapted to determine the portion of the elevator shaft in which the elevator car is located from the selected phase offset by:
selecting the first phase offset when the first phase offset is in a range greater than 90° or π/2 rad and less than 270° or 3*π/2 rad; and
selecting the second phase offset when the first phase offset is not in the range.

16. The system according to claim 11 wherein the transmitter emits the modulated electromagnetic radiation with a second modulation frequency, lower than the first modulation frequency, as a second output signal, and the evaluation unit determines, based upon the second output signal, the portion of the elevator shaft in which the elevator car is currently located.

17. The system according to claim 16 wherein the transmitter emits the second output signal only when the elevator car is at a standstill.

18. The system according to claim 16 wherein the transmitter emits the second output signal when the evaluation unit has no information about the portion of the elevator shaft in which the elevator car is currently located.

19. The system according to claim 11 wherein the sensor cell is included in a 3-D sensor having a plurality of the sensor cell.

20. A method for determining a position of an elevator car movably arranged in an elevator shaft of an elevator installation, the elevator installation including the system according to claim 11, the method comprising the steps of:
operating the evaluation unit to
delay the original measurement signal by the predetermined delay time and thus generate the delayed measurement signal,
determine the first phase offset between the original measurement signal and the first output signal,
determine the second phase offset between the delayed measurement signal and the first output signal,
select either the first phase offset or the second phase offset based upon the predetermined selection condition and determine the position of the elevator car within the portion of the elevator shaft from the selected phase offset, and
determine the position of the elevator car in the elevator shaft based upon the arrangement of the portion in the elevator shaft and the position of the elevator car within the portion.
